(19) United States
(12) Patent Application Publication
(10) Pub. No.: US 2023/0120147 A1
(43) Pub. Date: Apr. 20, 2023

(54) VIRTUAL OBJECT CONTROL METHOD AND APPARATUS, COMPUTER DEVICE, AND STORAGE MEDIUM

(71) Applicant: Tencent Technology (Shenzhen) Company Limited, Shenzhen (CN)

(72) Inventor: Changbin Xu, Shenzhen (CN)

(73) Assignee: Tencent Technology (Shenzhen) Company Limited, Shenzhen (CN)

(21) Appl. No.: 17/818,453

(22) Filed: Aug. 9, 2022

Related U.S. Application Data
(63) Continuation of application No. PCT/CN2021/076223, filed on Feb. 9, 2021.

(30) Foreign Application Priority Data
Apr. 9, 2020 (CN) 202010273075.2

(51) Int. Cl. A63F 13/56; A63F 13/533; G06F 3/0488; G06F 3/0484; G06F 3/0482

(52) U.S. Cl. CPC A63F 13/56; A63F 13/533; G06F 3/0488; G06F 3/0484; G06F 3/0482; A63F 2300/308; A63F 2300/6607; G06F 2203/04803

(57) ABSTRACT

A virtual object control method includes obtaining a panel presentation instruction generated through triggering on a user interface (UI) and presenting an interaction control panel on the UI in response to the panel presentation instruction. When an interaction button or a movement on the interaction control panel is triggered, and the interaction button is associated with an object selection panel, the interaction control panel is replaced with the object selection panel in the UI. A to-be-controlled virtual object is selected through the object selection panel and the selected virtual object to perform interaction is controlled according to an interaction corresponding to the interaction button.

### RELATED APPLICATION

This application claims priority to PCT Application No. PCT/CN2021/076223, filed on Feb. 9, 2021, entitled “VIRTUAL OBJECT CONTROL METHOD AND APPARATUS, COMPUTER DEVICE, AND STORAGE MEDIUM” which claims priority to Chinese Patent Application No. 2020102730752, entitled “VIRTUAL OBJECT CONTROL METHOD AND APPARATUS, COMPUTER DEVICE, AND STORAGE MEDIUM” filed with the National Intellectual Property Administration, PRC on Apr. 9, 2020, both of which are incorporated herein by reference in their entirety.

### FIELD OF THE TECHNOLOGY

This application relates to the field of computer technologies, and in particular, to a virtual object control method and apparatus, a computer device, and a storage medium.

### BACKGROUND OF THE DISCLOSURE

In an interactive virtual scene, a user may interact, by controlling one or more virtual objects, with a virtual object controlled by an opposing side (such as another user or a computer program). For example, the user selects a tactic or a skill on a user interface (UI), and then selects a virtual object that is about to execute the tactic or the skill on the UI, to control the virtual object to interact with the virtual object controlled by the opposing side. However, when the virtual object that needs to be controlled by the user is blocked by a virtual object in an own camp or an opposing camp in the UI, the user cannot select the virtual object to be controlled, thereby reducing the interaction effect.

### SUMMARY

According to embodiments of this application, a virtual object control method and apparatus, a computer device, and a storage medium are provided.

A virtual object control method is provided, performed by a terminal, the method including:

obtaining a panel presentation instruction generated through triggering on an UI;

presenting an interaction control panel on the UI in response to the panel presentation instruction;

when an interaction button on the interaction control panel is triggered, and the interaction button is associated with an object selection panel, obtaining an interaction manner corresponding to the triggered interaction button, and replacing the interaction control panel with the object selection panel in the UI;

when a virtual object selection button on the object selection panel is triggered, selecting a to-be-controlled virtual object corresponding to the triggered virtual object selection button; and

controlling, according to the interaction manner, the selected virtual object to perform interaction.

A virtual object control apparatus is provided, including:

an obtaining module, configured to obtain a panel presentation instruction generated through triggering on an UI;

a presentation module, configured to present an interaction control panel on the UI in response to the panel presentation instruction;

an update module, configured to, when an interaction button on the interaction control panel is triggered, and the interaction button is associated with an object selection panel, replace the interaction control panel with the object selection panel in the UI;

a selection module, configured to select a to-be-controlled virtual object through the object selection panel; and

a control module, configured to control the selected virtual object to perform interaction according to an interaction manner corresponding to the interaction button.

A computer device is provided, including a memory and a processor, the memory storing a computer program, the processor, when executing the computer program, implementing the following operations:

obtaining a panel presentation instruction generated through triggering on an UI;

presenting an interaction control panel on the UI in response to the panel presentation instruction;

when an interaction button on the interaction control panel is triggered, and the interaction button is associated with an object selection panel, obtaining an interaction manner corresponding to the triggered interaction button, and replacing the interaction control panel with the object selection panel in the UI;

when a virtual object selection button on the object selection panel is triggered, selecting a to-be-controlled virtual object corresponding to the triggered virtual object selection button; and

controlling, according to the interaction manner, the selected virtual object to perform interaction.

A computer-readable storage medium is provided, storing a computer program, the computer program, when executed by a processor, implementing the following operations:

obtaining a panel presentation instruction generated through triggering on an UI;

presenting an interaction control panel on the UI in response to the panel presentation instruction;

when an interaction button on the interaction control panel is triggered, and the interaction button is associated with an object selection panel, obtaining an interaction manner corresponding to the triggered interaction button, and replacing the interaction control panel with the object selection panel in the UI;

when a virtual object selection button on the object selection panel is triggered, selecting a to-be-controlled virtual object corresponding to the triggered virtual object selection button; and

controlling, according to the interaction manner, the selected virtual object to perform interaction.

A virtual object control method is provided, including:

obtaining a panel presentation instruction generated through triggering on an UI;

presenting an object selection panel on the UI in response to the panel presentation instruction;

when a virtual object selection button on the object selection panel is triggered, and the virtual object selection button is associated with an interaction control panel, replacing the object selection panel with the interaction control panel in the UI;

selecting a to-be-controlled virtual object corresponding to the virtual object selection button; and

controlling the selected virtual object to perform interaction according to an interaction manner on the interaction control panel.

A virtual object control apparatus is provided, including:

an obtaining module, configured to obtain a panel presentation instruction generated through triggering on an UI;

a presentation module, configured to present an object selection panel on the UI in response to the panel presentation instruction;

an update module, configured to, when a virtual object selection button on the object selection panel is triggered, and the virtual object selection button is associated with an interaction control panel, replace the object selection panel with the interaction control panel in the UI;

a selection module, configured to select a to-be-controlled virtual object corresponding to the virtual object selection button; and

a control module, configured to control the selected virtual object to perform interaction according to an interaction manner on the interaction control panel.

A computer device is provided, including a memory and a processor, the memory storing a computer program, the processor, when executing the computer program, implementing the following operations:

obtaining a panel presentation instruction generated through triggering on an UI;

presenting an object selection panel on the UI in response to the panel presentation instruction;

when a virtual object selection button on the object selection panel is triggered, and the virtual object selection button is associated with an interaction control panel, replacing the object selection panel with the interaction control panel in the UI;

selecting a to-be-controlled virtual object corresponding to the virtual object selection button; and

controlling the selected virtual object to perform interaction according to an interaction manner on the interaction control panel.

A computer-readable storage medium is provided, storing a computer program, the computer program, when executed by a processor, implementing the following operations:

obtaining a panel presentation instruction generated through triggering on an UI;

presenting an object selection panel on the UI in response to the panel presentation instruction;

when a virtual object selection button on the object selection panel is triggered, and the virtual object selection button is associated with an interaction control panel, replacing the object selection panel with the interaction control panel in the UI;

selecting a to-be-controlled virtual object corresponding to the virtual object selection button; and

controlling the selected virtual object to perform interaction according to an interaction manner on the interaction control panel.

A computer program product or a computer program is provided, the computer program product or the computer program including computer instructions, the computer instructions being stored in a computer-readable storage medium. A processor of a computer device reads the computer instructions from the computer-readable storage medium and executes the computer instructions, causing the computer device to perform the operations in the foregoing virtual object control method.

Details of one or more embodiments of this application are provided in the following accompany drawings and descriptions. Other features and advantages of this application become apparent from the specification, the accompanying drawings, and the claims.

### BRIEF DESCRIPTION OF THE DRAWINGS

The accompanying drawings described herein are used for providing a further understanding of this application, and form part of this application. Example embodiments of this application and descriptions thereof are used for explaining this application, and do not constitute any inappropriate limitation to this application. In the accompanying drawings:

FIG. 1 is a diagram of an application environment of a virtual object control method in an embodiment.

FIG. 2 is a schematic flowchart of a virtual object control method in an embodiment.

FIG. 3 is a schematic diagram of presenting an interaction control panel in a game of a basketball match in an embodiment.

FIG. 4 is a schematic diagram of presenting an interaction control panel according to a quantity of tactics in an embodiment.

FIG. 5 is a schematic diagram of displaying buttons of executable and non-executable tactics in an interaction control panel in an embodiment.

FIG. 6 is a schematic diagram of presenting an interaction control panel in an UI according to a specified position and a position of a panel presentation button in an embodiment.

FIG. 7 is a schematic diagram of triggering a corresponding interaction control button during sliding of a panel presentation button and presentation of an interaction control panel in an embodiment.

FIG. 8 is a schematic diagram of presenting an object selection panel in an UI in an embodiment.

FIG. 9 is a schematic flowchart of a virtual object control method in another embodiment.

FIG. 10 is a schematic diagram of triggering a corresponding object selection button during sliding of a panel presentation button and presentation of an object selection panel in an embodiment.

FIG. 11 is a schematic diagram of switching from a first object selection panel to an interaction control panel, and then switching to a second object selection panel in an embodiment.

FIG. 12 is a schematic flowchart of a virtual object control method in another embodiment.

FIG. 13 is a schematic diagram of switching from a tactical wheel to a player selection wheel when a switching condition is met in an embodiment.

FIG. 14 is a schematic diagram of executing a corresponding logic function when a user releases a finger in advance in an embodiment.

FIG. 15 is a schematic diagram of whether a tactical wheel is associated with a player selection wheel in an embodiment.

FIG. 16 is a structural block diagram of a virtual object control apparatus in an embodiment.

FIG. 17 is a structural block diagram of a virtual object control apparatus in another embodiment.

FIG. 18 is a structural block diagram of a virtual object control apparatus in another embodiment.

FIG. 19 is a diagram of an internal structure of a computer device in an embodiment.

### DESCRIPTION OF EMBODIMENTS

To make the objectives, technical solutions, and advantages of this application clearer and more understandable, this application is further described in detail below with reference to the accompanying drawings and the embodiments. The specific embodiments described herein are only used for explaining this application, and are not used for limiting this application.

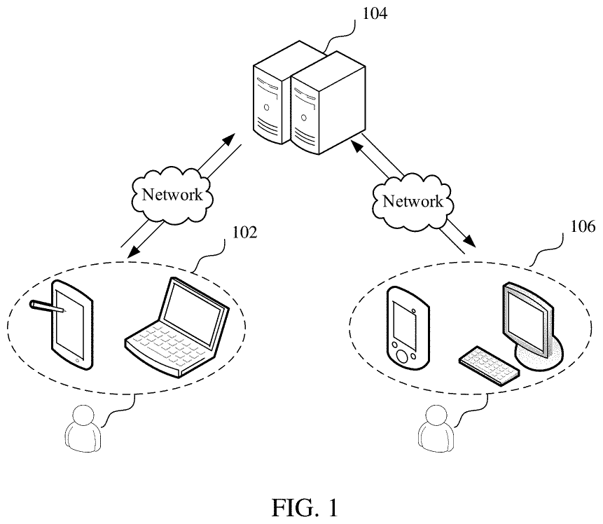

A virtual object control method provided in this application is applicable to an application environment shown in FIG. 1. A terminal 102, a server 104, and a terminal 106 communicate with each other through a network. The terminal 102 obtains a panel presentation instruction generated through triggering on an UI; presents an interaction control panel on the UI in response to the panel presentation instruction; when an interaction button on the interaction control panel is triggered, and the interaction button is associated with an object selection panel, replaces the interaction control panel with the object selection panel in the UI; selects a to-be-controlled virtual object through the object selection panel; and controls, according to an interaction manner corresponding to the interaction button, the selected virtual object to interact with a virtual object controlled by the terminal 106 (that is, a role controlled by an opposing player); or controls, according to an interaction manner corresponding to the interaction button, the selected virtual object to interact with a virtual object controlled by a program in the server 104 (that is, a role controlled by a non-player); or controls, according to an interaction manner corresponding to the interaction button, the selected virtual object to interact with a virtual object controlled by a program in the terminal 102 (that is, a role that is controlled by a non-player). Although referred to as a button or interaction button, it may also be referred to as a movement detector, movement interaction, a selection mechanism, a selectable component, or a trigger. As described below, there may be interaction buttons that merely track movement of the user at any location on the screen or at a different location from a panel/display showing the movements that can be detected. In such examples, the movement may be referred to as a button.

The terminal 102 is a terminal held by a local end user, and the terminal 106 is a terminal held by an opposing user. The terminal 102 and the terminal 104 may be, but not limited to, a personal computer, a notebook computer, a smartphone, a tablet computer, and a portable wearable device. The server 104 may be implemented by an independent server or a server cluster including a plurality of servers.

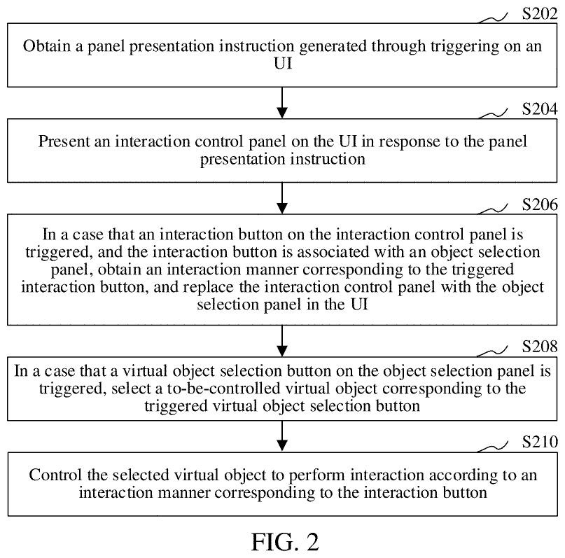

In an embodiment, as shown in FIG. 2, a virtual object control method is provided. An example in which the method is applicable to the terminal 102 in FIG. 1 is used for description. The method includes the following steps:

S202. Obtain a panel presentation instruction generated through triggering on an UI.

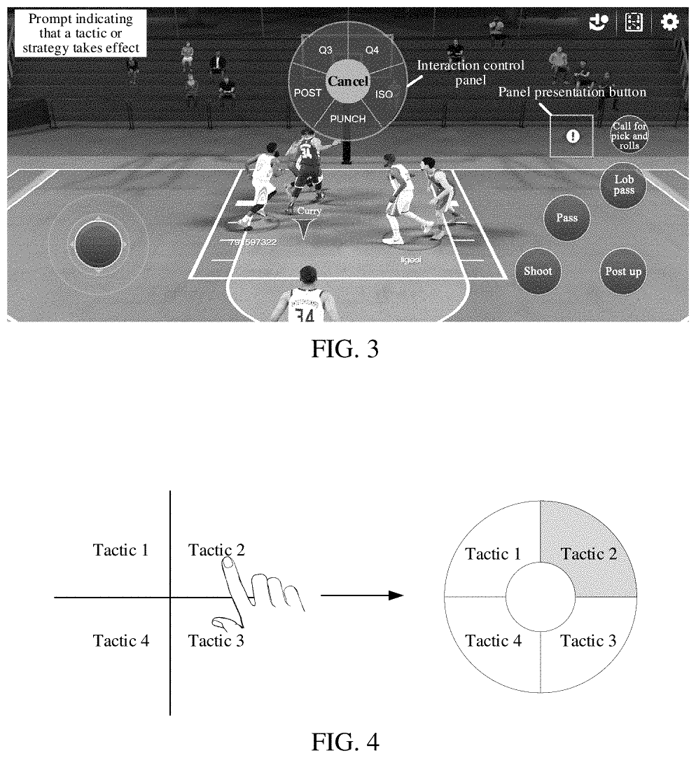

The UI is an interface used when the user performs an interaction task. The interaction task may be a virtual sports game, a shooting game, or a spell game. For example, as shown in FIG. 3, when being playing a game, the user may control a virtual object through the UI, for example, control a player to perform an interaction action such as shooting, passing, or posting up. The foregoing trigger may be triggered through touching or sliding.

In an embodiment, the terminal displays the UI, and presents a virtual environment picture in the UI. The virtual environment picture displays virtual objects of a different camp.

The virtual environment picture is a picture of a virtual environment generated by a computer. The virtual environment may be a game scene. The virtual environment provides a multimedia virtual world. The user may control a virtual object through a control on the UI, or the user directly controls an operable virtual object in the virtual environment, observes items, characters, scenery, and the like in the virtual environment from a perspective of the virtual object, and performs interaction by using the virtual object and another virtual object in the virtual environment (such as a role controlled by another player or a role controlled by a non-player).

The virtual environment is generally a two-dimensional or multidimensional virtual environment generated by an application program in a computer device such as a terminal, and is then presented by using hardware (for example, a screen) in the terminal, to obtain a visible virtual environment picture. The terminal may be a mobile terminal such as a smartphone, a tablet computer, or an eBook reader. Alternatively, the terminal may be a personal computer device such as a notebook computer or a fixed computer.

The foregoing virtual objects of a different camp may be a movable virtual object controlled by a local end user in a virtual environment, and a virtual object controlled by an opposing user or controlled by a computer program (that is, controlled by a non-player). There may be one or more virtual objects controlled by a local end. There may alternatively be one or more virtual objects controlled by the opposing user or the computer program.

Each virtual object has a respective shape and size in the virtual environment, and occupies some space in the virtual environment. The foregoing camps may include an own camp to which the local end user belongs and an opposing camp (or an enemy camp) to which the opposing user belongs, or an own camp to which the local end user belongs and an opposing camp (or an enemy camp) to which the non-player belongs.

In an embodiment, S202 may include: obtaining, by a terminal, a panel presentation instruction generated through triggering on a panel presentation button of the UI.

For example, when the user clicks a panel presentation button of the UI in FIG. 3, a panel presentation instruction is generated, to present an interaction control panel on the UI.

In an embodiment, the foregoing step of obtaining a panel presentation instruction generated through triggering on a panel presentation button of the UI may include: obtaining, by the terminal, a panel presentation instruction generated through touching on the panel presentation button of the UI; or obtaining a panel presentation instruction generated through sliding on the panel presentation button of the UI.

In an embodiment, the terminal calculates a touch duration during touching on the panel presentation button. When the touch duration reaches a preset touch duration, and it indicates that the user is performing a long press operation, S204 is performed. When the touch duration does not reach the preset touch duration, the terminal obtains an interaction manner used during previous interaction, and controls a currently controlled virtual object to perform interaction according to the obtained interaction manner.

For example, when the user touches the panel presentation button of the UI, it is detected whether the touch duration reaches a preset touch duration. If the preset touch duration is reached, it indicates that the user intends to open the interaction control panel. If the preset touch duration is not reached, it indicates that the user intends to execute an interaction manner of previous interaction, or it indicates that a current operation of the user is a misoperation.

S204. Present an interaction control panel on the UI in response to the panel presentation instruction.

The interaction control panel may be a control panel of a wheel type or a control panel of another type. For example, the interaction control panel may be a tactical wheel or a spell wheel. Interaction buttons of different interaction manners are disposed on the interaction control panel. When one of the interaction buttons is selected, the virtual object may be controlled for interaction in an interaction manner corresponding to the interaction button. In different interaction tasks, corresponding interaction manners are also different. For example, in a virtual sports game, the interaction manners may be a pick-and-roll tactic, a defense tactic, a foul tactic, and the like.

An example interaction control panel of the wheel type is described with respect to and shown in FIG. 3. Five tactics: Q3, Q4, POST, ISO, and PUNCH tactics are set in the control panel.

In an embodiment, the terminal determines a quantity of interaction manners, and determines an interaction button region of the interaction control panel according to the quantity of interaction manners. For example, as shown in FIG. 4, if it is determined that there are 4 tactics, a to-be-presented interaction control panel is divided into 4 interaction button regions, and the interaction control panel is further divided into a function region used for canceling presentation of the interaction control panel, for example, five regions such as a tactic 1, a tactic 2, a tactic 3, a tactic 4, and a cancellation function.

In an embodiment, when controlling a virtual object (where there may be one or more virtual objects) to perform an interaction task, the user may have a corresponding level. There is a difference between interaction manners of different levels. That is, a higher level indicates a richer interaction manner. The presented interaction control panel displays interaction buttons corresponding to a plurality of interaction manners. The terminal determines a level of the user. When the terminal determines according to the level whether the user may use an interaction manner corresponding to an interaction button in the interaction control panel, if the terminal determines that the user cannot use a specific interaction manner, the interaction button corresponding to the interaction manner is displayed in the interaction control panel in a different display manner, to prompt the user that the interaction manner is not available.

The level of the user can be an ordinary level and a membership level, and the membership level is higher than the ordinary level. The membership level may be further subdivided into membership levels of different levels, such as a gold level and a diamond level. The membership level may be set differently for different embodiments. In addition, the level of the user may be a level accumulated when the user performs an interaction task.

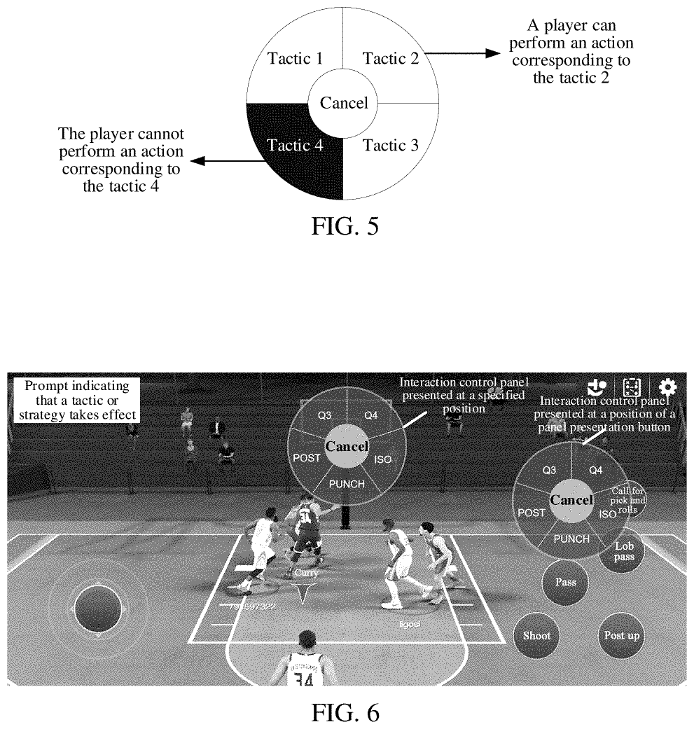

A competition game is used as an example for description. If the tactic 4 cannot be used at the level of the user, a button of the tactic 4 in the interaction control panel displays a different color from other buttons. As shown in FIG. 5, when the user clicks a button of the tactic 2, the player may perform an action corresponding to the tactic 2; and when the user clicks a button of the tactic 4, the player cannot perform an action corresponding to the tactic 4.

In addition, ability values corresponding to the interaction manners of different levels may alternatively be different. For example, a higher level indicates a larger ability value corresponding to an interaction manner. That is, when a same interaction manner is used, a higher level indicates stronger interactivity. For example, in a spell game of the user, when both sides use a same spell for fighting, one side at a higher level has a stronger damage power or attack power.

In an embodiment, S204 may include: at a position of the panel presentation button or at a specified position in the UI, presenting, by the terminal, the interaction control panel on the UI in a manner of a pop-up window or a popover.

If the interaction control panel is presented on the UI in the manner of the popover, the interaction control panel and other backgrounds may be semi-transparent.

For example, as shown in FIG. 6, the terminal may present an interaction control panel at a specified position of an UI (an upper middle position in FIG. 6). The terminal may alternatively present an interaction control panel at a position of a panel presentation button.

In an embodiment, for the position at which the interaction control panel is presented, the user may set the position on a setting page, such as set an upper left, lower left, upper right, upper right, or middle position in FIG. 6. In an alternative embodiment, the location may be set outside of a main focus or center portion of the screen at the margins to avoid interfering with the main focus or center portion.

S206. When an interaction button on the interaction control panel is triggered, and the interaction button is associated with an object selection panel, obtain an interaction manner corresponding to the triggered interaction button, and replace the interaction control panel with the object selection panel in the UI.

The object selection panel displays buttons with a plurality of virtual object identifiers (where the button is a virtual object selection button), and the user may click or touch a corresponding virtual object selection button, to select a virtual object that needs to perform interaction and corresponds to the interaction button. For example, the object selection panel may be a player selection wheel or a role selection wheel.

The foregoing association may include an association relationship between the interaction button and the object selection panel. The association relationship may be a link relationship. For example, the object selection panel may be linked by triggering the interaction button, to display the object selection panel in the UI.

The foregoing replacement may include a process of panel switching and display. Correspondingly, the foregoing step of replacing the interaction control panel with the object selection panel in the UI may include: switching the interaction control panel to the object selection panel, to display the object selection panel in the UI.

In an embodiment, when the panel presentation instruction is an instruction generated through sliding on the panel presentation button, the terminal obtains a sliding direction during sliding and/or an end position; triggers the interaction button on the interaction control panel according to the sliding direction and/or the end position; and obtains the interaction manner corresponding to the triggered interaction button. Consequently, the user does not need to click or touch a corresponding interaction button on the interaction control panel again to select a corresponding interaction manner, which reduces operations of the user, so that the virtual object may be quickly controlled to perform corresponding interaction, and the user experience is improved.

In an embodiment, if the panel presentation instruction is generated through sliding on the panel presentation button of the UI, when presenting the interaction control panel, the terminal does not need to receive a touch operation of the user again, only needs to obtain an end position of the sliding, and may determine according to the end position that which interaction button on the interaction control panel is triggered.

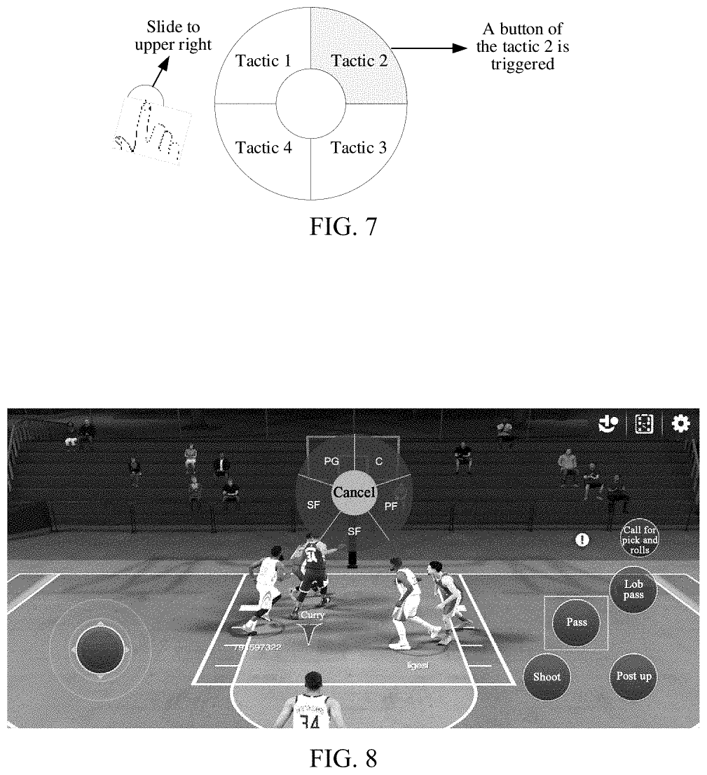

For example, as shown in FIG. 7, the user performs sliding on a panel presentation button. If the user performs sliding to upper right, it may be determined that a button of a tactic 2 is triggered. In addition, the user performs sliding on the panel presentation button, and if an end position falls on the button of the tactic 2 in FIG. 7, it is determined that the button of the tactic 2 is triggered.

In an embodiment, S206 may include: obtaining, by the terminal, an operation instruction generated by triggering the interaction button in the interaction control panel; determining, when the operation instruction is obtained, whether the interaction button is associated with the object selection panel; determining, when the interaction button is associated with the object selection panel, a first maintaining duration during which the interaction button is triggered; and when the first maintaining duration reaches a first preset duration, replacing the interaction control panel with the object selection panel in the UI.

The first maintaining duration may be a duration maintained during which the interaction button is triggered. For example, when the user touches the interaction button, the first maintaining duration may be a duration of the user touching the interaction button.

For example, if the panel presentation instruction is generated through touching on the panel presentation button of the UI, the terminal needs to receive a touch instruction of the user again when presenting the interaction control panel. When receiving the touch instruction generated through touching on the interaction button on the interaction control panel, the terminal determines that the interaction button on the interaction control panel is triggered. If the panel presentation instruction is generated through sliding on the panel presentation button of the UI, when presenting the interaction control panel, the terminal does not need to receive a touch operation of the user again, only needs to obtain an end position of the sliding, and may determine according to the end position that which interaction button on the interaction control panel is triggered. For example, if the end position falls on the button of the tactic 2 in FIG. 7, the button of the tactic 2 is triggered.

In an embodiment, the foregoing step of replacing the interaction control panel with the object selection panel in the UI may include: canceling, by the terminal, presentation of the interaction control panel in the UI; and presenting an object selection panel on the UI. A presentation position of the object selection panel may be the same as a presentation position of the interaction control panel.

In an embodiment, when the interaction button on the interaction control panel is triggered, the terminal determines whether the interaction button is associated with the object selection panel. When the interaction button is associated with the object selection panel, the terminal performs an animation prompt at an edge of the interaction control panel; obtains object selection panel data; renders the object selection panel data to obtain the object selection panel; and performs S204 when the first maintaining duration reaches a first preset duration.

The animation prompt may be playing a ripple animation, that is, playing an animation in which ripples are simulated. In addition, the animation prompt may alternatively be an animation in another form, such as a flashing moving circle around the interaction control panel.

In an embodiment, the terminal obtains animation data, invokes a rendering tool to render the animation data, to obtain a corresponding animation, and then plays the animation around the interaction control panel.

In an embodiment, the terminal obtains object selection panel data, invokes a rendering tool to render the object selection panel data, to obtain an object selection panel, then obtains a position of the interaction control panel, cancels the playback of the animation, and displays the object selection panel at the position.

For example, the terminal invokes a Web Graphics Library (WebGL), or an open graphics library for embedded system (OpenGL ES), or an OpenGL ES2.0 version, to render ripple animation data and the object selection panel data, to separately obtain a ripple animation and the object selection panel.

In an embodiment, S206 may include: canceling, by the terminal, presentation of the interaction control panel, and at a position of the interaction control panel or at a specified position in the UI, presenting the object selection panel on the UI in a manner of a pop-up window or a popover.

If the object selection panel is presented on the UI in the manner of the popover, the object selection panel and other backgrounds may be semi-transparent.

For example, as shown in FIG. 8, the terminal may present an object selection panel at a specified position of an UI (an upper middle position in FIG. 8). The terminal may alternatively present an object selection panel at a position of a panel presentation button. In some embodiments, the position may be in a margin of the screen or outside of a center portion or main focus of the screen to avoid interfering with the center portion or main focus of the display. In FIG. 8, the object selection buttons include: a PG button, an SG button, an SF button, a PF button, and a C button. PG represents a point guard in a basketball game, SG represents a shooting guard, SF represents small forward, PF represents power forward, and C represent center.

In an embodiment, for the position at which the object selection panel is presented, the user may set the position on a setting page, such as set an upper left, lower left, upper right, upper right, or middle position in FIG. 8.

S208. When a virtual object selection button on the object selection panel is triggered, select a to-be-controlled virtual object corresponding to the triggered virtual object selection button.

The to-be-controlled virtual object may be a virtual object that the user intends to control. The virtual object may be an object that performs another interaction task on the court, or may be an object that is resting off the court. For example, for a sports game, the to-be-controlled virtual object may be a player that plays a game on the court. In addition, the to-be-controlled virtual object may alternatively be a player off the court. When a player off the court is selected, the selected player may play a game on the court.

In an embodiment, the terminal selects a to-be-controlled virtual object presented in the UI by triggering the virtual object selection button on the object selection panel. For example, as shown in FIG. 8, when the user triggers the PG button in the object selection panel, it indicates that the to-be-controlled virtual object is the point guard in the game.

In an embodiment, S208 may include: determining, by the terminal, a triggered virtual object selection button in the object selection panel; obtaining a virtual object identifier corresponding to the triggered virtual object selection button; and selecting the to-be-controlled virtual object according to the virtual object identifier from a plurality of virtual objects.

In an embodiment, the step of selecting the to-be-controlled virtual object according to the virtual object identifier from a plurality of virtual objects includes: selecting, by the terminal, the to-be-controlled virtual object according to the virtual object identifier from a plurality of virtual objects presented in the UI.

For example, as shown in FIG. 8, if the user triggers the PG button in the object selection panel, a PG player identifier corresponding to the PG button is obtained, and a point guard that plays a game in the game is selected according to the PG player identifier.

In an embodiment, when triggering of the virtual object selection button in the object selection panel ends, the terminal calculates a second maintaining duration after the triggering ends; and when the second maintaining duration reaches a second preset duration, and none of virtual object selection buttons in the object selection panel is triggered, cancels presentation of the presented object selection panel in the UI.

In an embodiment, before the canceling presentation of the object selection panel, the terminal may determine a presentation position of the object selection panel. When the presentation of the object selection panel is canceled, the terminal may present the interaction control panel at the presentation position.

S210. Control the selected virtual object to perform interaction according to an interaction manner corresponding to the interaction button.

In an embodiment, the terminal controls, according to the interaction manner corresponding to the interaction button, the selected virtual object to interact with a virtual object in an opposing camp.

For example, a game of a basketball match is used as an example. If an opposing player makes a ball-holding attack, the panel presentation button may be clicked, the terminal then presents an interaction control panel in the UI, and a corresponding foul tactic button is clicked on the interaction control panel, to take a foul tactic. Then, the terminal displays an object selection panel, the user selects a corresponding player selection button on the object selection panel, to select a player that intends to execute the foul tactic, and the selected player then fouls the opposing player.

In an embodiment, when the interaction button on the interaction control panel is triggered, but the interaction button is not associated with the object selection panel, the terminal obtains the interaction manner corresponding to the triggered interaction button; and controls a default virtual object to perform interaction according to the obtained interaction manner. The default virtual object may be a virtual object that the user currently controls. For example, a game of a basketball match is used as an example. The user currently controls a ball-holding player to make an attack, during the attack, encounters defense of an opposing player, and in this case, may get rid of the defense of the opposing player by using a pick-and-roll tactic. One specific process may be as follows: The user clicks the panel presentation button, the terminal then presents an interaction control panel in the UI, and a corresponding pick-and-roll tactic button is clicked on the interaction control panel, to take a pick-and-roll tactic. Then, the terminal displays an object selection panel, the user clicks a corresponding virtual object selection button on the object selection panel, to select a player that intends to execute the pick-and-roll tactic, and the selected player performs a pick-and-roll.

In the foregoing embodiment, by setting the panel presentation button on the UI, when a panel presentation instruction is received, an interaction control panel is presented on the UI, and the user may trigger an interaction button on the interaction control panel to select a corresponding interaction manner. In addition, when the interaction button is triggered and the interaction button is associated with an object selection panel, the object selection panel is displayed, and a to-be-controlled virtual object is selected for interaction through the object selection panel. Consequently, the user does not need to click a to-be-selected virtual object for selection on the UI, thereby effectively avoiding a problem that the to-be-controlled virtual object cannot be selected because the to-be-controlled virtual object is blocked, and improving the interaction effect. In addition, although the virtual objects are displayed excessively small in the UI and a quantity is excessively large, the user does not need to select a to-be-controlled virtual object by zooming in a display multiples, and only needs to use the object selection panel to quickly and accurately select the to-be-controlled virtual object for interaction, thereby effectively avoiding a problem of a misoperation, speeding up a selection rate of the virtual object, also improving the accuracy of selecting the virtual object, and improving the interaction efficiency. In addition, even if all the virtual objects are in a moving state in the UI, the to-be-controlled virtual object may be quickly and accurately selected for interaction through the object selection panel, thereby avoiding a problem of a wrong selection due to a movement of the virtual objects. Finally, by setting the interaction control panel and the object selection panel, even in a fast-paced human-computer interaction scenario, a required interaction manner and a to-be-controlled virtual object may alternatively be quickly and accurately selected or switched to, and that excessive interaction buttons set in the UI affect the user operation and the visual effect is further avoided.

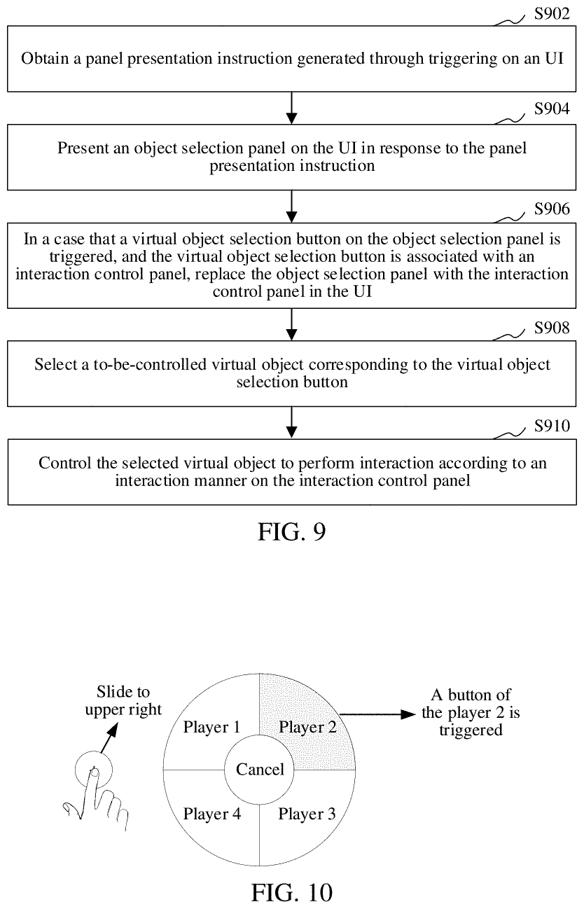

In an embodiment, as shown in FIG. 9, a virtual object control method is provided. An example in which the method is applicable to the terminal 102 in FIG. 1 is used for description. The method includes the following steps:

S902. Obtain a panel presentation instruction generated through triggering on an UI.

The UI is an interface used when the user performs an interaction task. The interaction task may be a virtual sports game, a shooting game, or a spell game. For example, as shown in FIG. 3, when being playing a game, the user may control a virtual object through the UI, for example, control a player to perform an interaction action such as shooting, passing, or posting up.

In an embodiment, the terminal displays the UI, and presents a virtual environment picture in the UI. The virtual environment picture displays virtual objects of a different camp.

The virtual environment picture is a picture of a virtual environment generated by a computer. The virtual environment may be a game scene. The virtual environment provides a multimedia virtual world. The user may control a virtual object through a control on the UI, or the user directly controls an operable virtual object in the virtual environment, observes items, characters, scenery, and the like in the virtual environment from a perspective of the virtual object, and performs interaction by using the virtual object and another virtual object in the virtual environment (such as a role controlled by another player or a role controlled by a non-player).

The virtual environment is generally a two-dimensional or multidimensional virtual environment generated by an application program in a computer device such as a terminal, and is then presented by using hardware (for example, a screen) in the terminal, to obtain a visible virtual environment picture. The terminal may be a mobile terminal such as a smartphone, a tablet computer, or an eBook reader. Alternatively, the terminal may be a personal computer device such as a notebook computer or a fixed computer.

The foregoing virtual objects of a different camp may be a movable virtual object controlled by a local end user in a virtual environment, and a virtual object controlled by an opposing user or controlled by a computer program (that is, controlled by a non-player). There may be one or more virtual objects controlled by a local end. There may alternatively be one or more virtual objects controlled by the opposing user or the computer program.

Each virtual object has a respective shape and size in the virtual environment, and occupies some space in the virtual environment. The foregoing camps may include an own camp to which the local end user belongs and an opposing camp (or an enemy camp) to which the opposing user belongs, or an own camp to which the local end user belongs and an opposing camp (or an enemy camp) to which the non-player belongs.

In an embodiment, S902 may include: obtaining, by the terminal, a panel presentation instruction generated through triggering on a panel presentation button of the UI.

For example, when the user clicks a panel presentation button of the UI in FIG. 3, a panel presentation instruction is generated, to present an object selection panel on the UI.

In an embodiment, the foregoing step of obtaining a panel presentation instruction generated through triggering on a panel presentation button of the UI may include: obtaining, by the terminal, a panel presentation instruction generated through touching on the panel presentation button of the UI; or obtaining a panel presentation instruction generated through sliding on the panel presentation button of the UI.

In an embodiment, the terminal calculates a touch duration during touching on the panel presentation button. When the touch duration reaches a preset touch duration, and it indicates that the user is performing a long press operation, S904 is performed. When the touch duration does not reach the preset touch duration, the terminal obtains an interaction manner used during previous interaction, and controls a currently controlled virtual object to perform interaction according to the obtained interaction manner.

For example, when the user touches the panel presentation button of the UI, it is detected whether the touch duration reaches a preset touch duration. If the preset touch duration is reached, it indicates that the user intends to open the object selection panel. If the preset touch duration is not reached, it indicates that the user intends to execute an interaction manner of previous interaction, or it indicates that a current operation of the user is a misoperation.

S904. Present an object selection panel on the UI in response to the panel presentation instruction.

The object selection panel may be a control panel of a wheel type or a control panel of another type. The object selection panel displays buttons with a plurality of virtual object identifiers (where the button is a virtual object selection button), and the user may click or touch a corresponding virtual object selection button, to select a virtual object that needs to perform interaction and corresponds to the interaction button.

In an embodiment, when the panel presentation instruction is an instruction generated through sliding on the panel presentation button, the terminal obtains a sliding direction during sliding and/or an end position; triggers the virtual object selection button on the object selection panel according to the sliding direction and/or the end position; and obtains an interaction manner corresponding to the triggered virtual object selection button. Consequently, the user does not need to click or touch a corresponding virtual object selection button on the object selection panel again to select a corresponding virtual object, which reduces operations of the user, so that the corresponding virtual object that needs to be controlled may be quickly selected perform corresponding interaction, and the user experience is improved.

In an embodiment, if the panel presentation instruction is generated through sliding on the panel presentation button of the UI, when presenting the object selection panel, the terminal does not need to receive a touch operation of the user again, only needs to obtain an end position of the sliding, and may determine according to the end position that which virtual object selection button on the object selection panel is triggered.

For example, a competition game is used as an example. As shown in FIG. 10, the user performs sliding on a panel presentation button. If the user performs sliding to upper right, it may be determined that a button of a player 2 is triggered. In addition, the user performs sliding on the panel presentation button, and if an end position falls on the button of the player 2 in FIG. 10, it is determined that the button of the player 2 is triggered.

In an embodiment, S904 may include: at a position of the panel presentation button or at a specified position in the UI, presenting, by the terminal, the object selection panel on the UI in a manner of a pop-up window or a popover.

If the object selection panel is presented on the UI in the manner of the popover, the object selection panel and other backgrounds may be semi-transparent.

For example, as shown in FIG. 8, the terminal may present an object selection panel at a specified position of an UI (an upper middle position in FIG. 8). The terminal may alternatively present an object selection panel at a position of a panel presentation button. In FIG. 8, the object selection buttons include: a PG button, an SG button, an SF button, a PF button, and a C button. PG represents a point guard in a basketball game, SG represents a shooting guard, SF represents small forward, PF represents power forward, and C represent center.

In an embodiment, for the position at which the object selection panel is presented, the user may set the position on a setting page, such as set an upper left, lower left, upper right, upper right, or middle position in FIG. 8.

In an embodiment, the terminal determines a quantity of candidate virtual objects, and determines a virtual object selection button region of the interaction control panel according to the quantity of virtual objects. For example, as shown in FIG. 10, if it is determined that there are 4 players on the court, a to-be-presented interaction control panel is divided into 4 virtual object selection button regions, and the interaction control panel is further divided into a function region used for canceling presentation of the object selection panel, for example, five regions such as a tactic 1, a tactic 2, a tactic 3, a tactic 4, and a cancellation function.

S906. When a virtual object selection button on the object selection panel is triggered, and the virtual object selection button is associated with an interaction control panel, replace the object selection panel with the interaction control panel in the UI.

The interaction control panel may be a control panel of a wheel type or a control panel of another type. Interaction buttons of different interaction manners are disposed on the interaction control panel. When one of the interaction buttons is selected, the virtual object may be controlled for interaction in an interaction manner corresponding to the interaction button. In different interaction tasks, corresponding interaction manners are also different. For example, in a virtual sports game, the interaction manners may be a pick-and-roll tactic, a defense tactic, a foul tactic, and the like.

The foregoing association may include an association relationship between the virtual object selection button and the interaction control panel. The association relationship may be a link relationship. For example, the interaction control panel may be linked by triggering the virtual object selection button, to display the interaction control panel in the UI.

The foregoing replacement may include a process of panel switching and display. Correspondingly, the foregoing step of replacing the object selection panel with the interaction control panel in the UI may include: switching the object selection panel to the interaction control panel, to display the interaction control panel in the UI.

The interaction control panel of the wheel type is further described with respect to and shown in FIG. 3. Five tactics: Q3, Q4, POST, ISO, and PUNCH tactics are set in the control panel.

In an embodiment, the terminal determines a quantity of interaction manners, and determines an interaction button region of the interaction control panel according to the quantity of interaction manners. For example, as shown in FIG. 4, if it is determined that there are 4 tactics, a to-be-presented interaction control panel is divided into 4 interaction button regions, and the interaction control panel is further divided into a function region used for canceling presentation of the interaction control panel, for example, five regions such as a tactic 1, a tactic 2, a tactic 3, a tactic 4, and a cancellation function.

In an embodiment, when controlling a virtual object (where there may be one or more virtual objects) to perform an interaction task, the user may have a corresponding level. There is a difference between interaction manners of different levels. That is, a higher level indicates a richer interaction manner. The presented interaction control panel displays interaction buttons corresponding to a plurality of interaction manners. The terminal determines a level of the user. When the terminal determines according to the level whether the user may use an interaction manner corresponding to an interaction button in the interaction control panel, if the terminal determines that the user cannot use a specific interaction manner, the interaction button corresponding to the interaction manner is displayed in the interaction control panel in a different display manner, to prompt the user that the interaction manner is not available.

The level of the user can be an ordinary level and a membership level, and the membership level is higher than the ordinary level. The membership level may be further subdivided into membership levels of different levels, such as a gold level and a diamond level. There are multiple embodiments for setting the membership level. In addition, the level of the user may be a level accumulated when the user performs an interaction task.

A competition game is used as an example for description. If the tactic 4 cannot be used at the level of the user, a button of the tactic 4 in the interaction control panel displays a different color from other buttons. As shown in FIG. 5, when the user clicks a button of the tactic 2, the player may perform an action corresponding to the tactic 2; and when the user clicks a button of the tactic 4, the player cannot perform an action corresponding to the tactic 4.

In addition, ability values corresponding to the interaction manners of different levels may alternatively be different. For example, a higher level indicates a larger ability value corresponding to an interaction manner. That is, when a same interaction manner is used, a higher level indicates stronger interactivity. For example, in a spell game of the user, when both sides use a same spell for fighting, one side at a higher level has a stronger damage power or attack power.

S908. Select a to-be-controlled virtual object corresponding to the virtual object selection button.

In an embodiment, when a virtual object selection button on the object selection panel is triggered, the terminal selects a to-be-controlled virtual object according to the triggered virtual object selection button. For example, as shown in FIG. 8, when the user triggers the PG button in the object selection panel, it indicates that the to-be-controlled virtual object is the point guard in the game.

In an embodiment, S908 may include: when a virtual object selection button on the object selection panel is triggered, obtaining, by the terminal, a virtual object identifier corresponding to the triggered virtual object selection button; and selecting the to-be-controlled virtual object according to the virtual object identifier from a plurality of virtual objects presented in the UI.

For example, as shown in FIG. 8, if the user triggers the PG button in the object selection panel, a PG player identifier corresponding to the PG button is obtained, and a point guard that plays a game in the game is selected according to the PG player identifier.

In an embodiment, after S908, the terminal may alternatively cancel the presentation of the interaction control panel. When triggering of an interaction control button in the interaction control panel ends, the terminal calculates a second maintaining duration after the triggering ends; and when the second maintaining duration reaches a second preset duration, and none of virtual object selection buttons in the object selection panel is triggered, cancels presentation of the presented interaction control panel in the UI. For example, if touching the PG button in the object selection panel, the user selects the point guard that plays a game in the game. When the user stops the touch operation on the object selection panel and the second maintaining duration after the touch operation stops reaches the second preset duration, presentation of the presented interaction control panel in the UI is canceled.

In an embodiment, before the canceling presentation of the interaction control panel, the terminal may determine a presentation position of the interaction control panel. When the presentation of the interaction control panel is canceled, the terminal may present the interaction control panel at the presentation position.

S910. Control the selected virtual object to perform interaction according to an interaction manner on the interaction control panel.

In an embodiment, when the interaction button on the interaction control panel is triggered, the terminal controls, according to an interaction manner corresponding to the triggered interaction button, the selected virtual object to interact with a virtual object in an opposing camp.

For example, a game of a basketball match is used as an example. If an opposing player makes a ball-holding attack, the panel presentation button may be clicked, the terminal then presents an object selection panel in the UI, and a corresponding player selection button is clicked on the object selection panel, to select a corresponding player. Then, the terminal displays an interaction control panel, the user selects a corresponding foul tactic button on the interaction control panel, to select a tactic that the player intends to take, and the selected player then fouls the opposing player.

In an embodiment, when the interaction control button on the interaction control panel is triggered and the interaction control button is associated with another object selection panel, the currently displayed interaction control panel is replaced with the another object selection panel in the UI, to help the user select an opposing virtual object through the another object selection panel, so that the selected own virtual object interacts with the selected opposing virtual object in an interaction manner corresponding to the triggered interaction control button.

The another object selection panel may be a selection panel used for selecting a virtual object in an opposing camp.

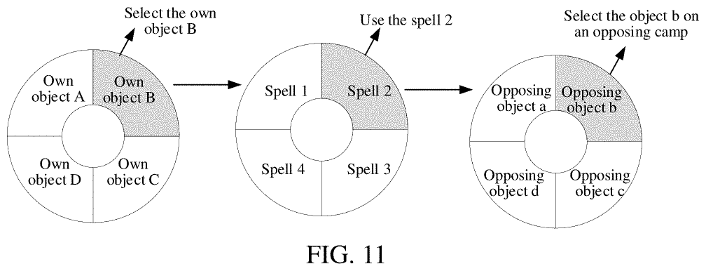

For example, as shown in FIG. 11, the user may select an own object B through a first object selection panel, then select a spell 2 through an interaction control panel, and finally select an object b on an opposing camp on a second object selection panel. After selecting the object b on the opposing camp, the user may use the own object B by using the spell 2 to attack the object b on the opposing camp.

In the foregoing embodiment, by setting the panel presentation button on the UI, when a panel presentation instruction is received, an object selection panel is presented on the UI, and the user may trigger a virtual object selection button on the object selection panel to select a to-be-controlled virtual object. In addition, when the virtual object selection button is triggered and the virtual object selection button is associated with an interaction control panel, the interaction control panel is displayed, and the virtual object is controlled for interaction by selecting an interaction manner corresponding to the interaction control panel. Consequently, the user does not need to click a to-be-selected virtual object for selection on the UI, thereby effectively avoiding a problem that the to-be-controlled virtual object cannot be selected because the to-be-controlled virtual object is blocked, and improving the interaction effect.

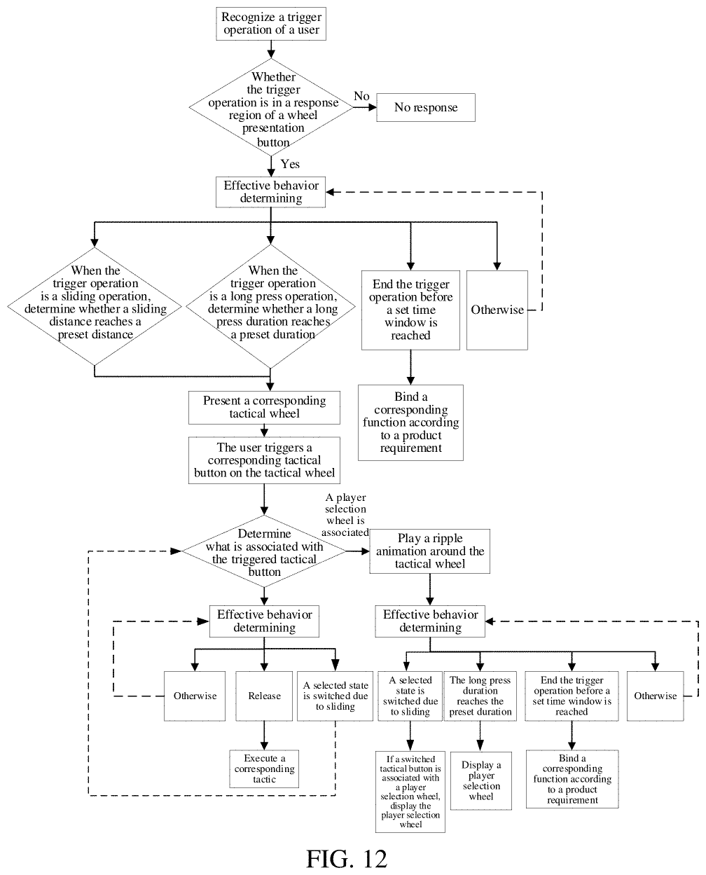

In an example, a game of a basketball match is used as an example. As shown in FIG. 12, specific content is as follows:

A trigger operation of the user is recognized, and whether the trigger operation is in a response region of a wheel presentation button is then determined. For example, long pressing or sliding is performed on an exclamation mark region in FIG. 3. If a finger keeps long pressing and sliding from another position to a corresponding button, it is determined that the trigger operation is a non-effective behavior, and no function is triggered, that is, no response is made. If the finger directly performs triggering in the response region of the wheel display button, the trigger operation is an effective behavior.

When it is determined that the trigger operation is the effective behavior, whether the trigger operation is a long press operation or a sliding operation is further detected. If the trigger operation is the sliding operation, whether a sliding distance reaches a preset threshold is determined. If the preset threshold is reached, a corresponding tactical wheel (that is, a wheel used for selecting tactics) is presented. If the trigger operation is the long press operation, whether a long press duration reaches a preset duration is determined. If the preset duration is reached, a corresponding tactical wheel is presented.

The foregoing tactical wheel includes several blocks. After the tactical wheel is displayed, there is always a tactical button in a selected state. The selected state in the tactical wheel changes with the sliding of the user's finger. In addition, a region corresponding to each tactical button on the tactical wheel may be in a gray state, and it indicates that a tactical button corresponding to the region is temporarily unavailable. Text in the wheel block is used for describing a specific name of the tactic, as shown in FIG. 4, such as a tactic 1, a tactic 2, a tactic 3, or a tactic 4.

When the user executes the trigger operation in the response region of the wheel display button, for example, the user long presses the exclamation mark region in FIG. 3, if the user ends the trigger operation before a set time window is reached, the tactical wheel is not displayed in this case, and a corresponding function may be determined according to an actual product requirement. For example, a previous tactic (for example, the tactic 4) is used for attack or defense.

After the tactical wheel is presented, according to whether the tactical button triggered on the presented tactical wheel is associated with another wheel (for example, a player selection wheel), the following two cases are described:

In a case 1, the player selection wheel is associated.

The user executes the trigger operation on the tactical button of the tactical wheel. As shown in FIG. 3, if an object of the trigger operation is a Q3 tactical button, whether the Q3 tactical button is associated with the player selection wheel is determined. If the player selection wheel is associated, an animation is played around the tactical wheel, and the player selection wheel is then displayed.

Before the player selection wheel is displayed, effective behavior determining is further made:

a) When the user executes the trigger operation on the tactical button of the tactical wheel, if the trigger operation is the long press operation, whether a long press duration corresponding to the long press operation reaches the preset duration is determined. If the preset duration is reached, the player selection wheel is displayed.

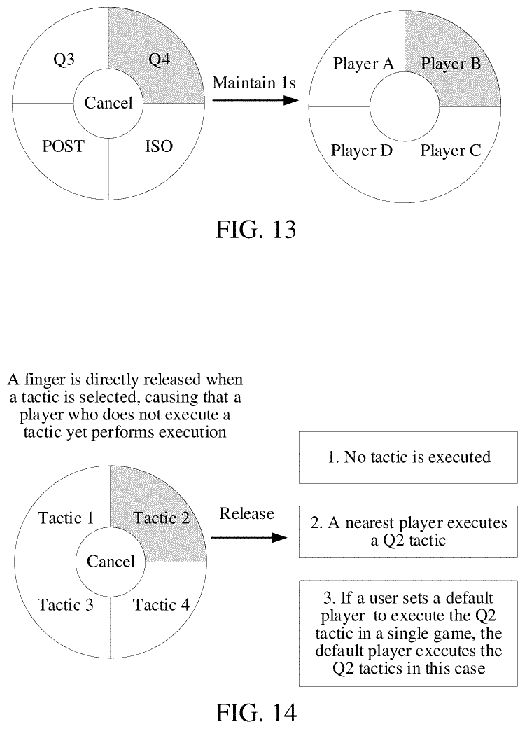

For example, if the long press duration reaches 1 s, the player selection wheel is displayed, as shown in FIG. 13.

b) When the user executes the trigger operation on the tactical button of the tactical wheel, if the trigger operation is the long press operation, and the long press duration does not reach the preset duration, the user releases the trigger operation, and binds a corresponding function according to an actual product requirement. As shown in FIG. 14, no tactic is executed; or the tactic 2 is executed through a nearest player. For example, if the tactic 2 is a defense tactic, a player nearest a ball-holding player is controlled to execute the tactic 2; or the user sets a default player to execute the tactic 2, and when the button of the tactic 2 is triggered, the default player is directly called to execute the tactic 2.

c) When the user executes the trigger operation on the tactical button of the tactical wheel, if the trigger operation is the sliding operation, whether another tactical button on the tactical wheel is slided to during sliding is determined. If the another tactical button is slided to, that is, a selected state is switched (the another tactical button is in a selected state), whether the another tactical button is associated with the player selection wheel continue to be determined. If the player selection wheel is associated, a long press duration of the user on the another tactical button continues to be determined. If the long press duration reaches the preset duration, the player selection wheel is displayed.

For example, if the user slides from the button of the tactic 1 to the button of the tactic 2, the selected state is switched from the button of the tactic 1 to the button of the tactic 2. If the button of the tactic 2 is associated with the player selection wheel, whether a long press duration of the user on the button of the tactic 2 is greater than or equal to 1 s is determined. If yes, the player selection wheel is displayed.

In a case 2, no another wheel is associated.

The user executes the trigger operation on the tactical button of the tactical wheel. As shown in FIG. 3, if an object of the trigger operation is the Q3 tactical button, whether the Q3 tactical button is associated with the player selection wheel is determined. If the player selection wheel is not associated, the trigger operation is determined (that is, an effective behavior is determined). If the user releases the tactical button, a default player executes a corresponding tactic. For example, the user sets the default player to execute the Q3 tactic. When the Q3 tactic button is triggered, the default player is directly called to execute the Q3 tactic.

When the trigger operation is determined, if the user's finger performs sliding, the selected state of the tactical button is switched, for example, the selected state is switched from the Q3 tactical button to a Q4 tactical button.

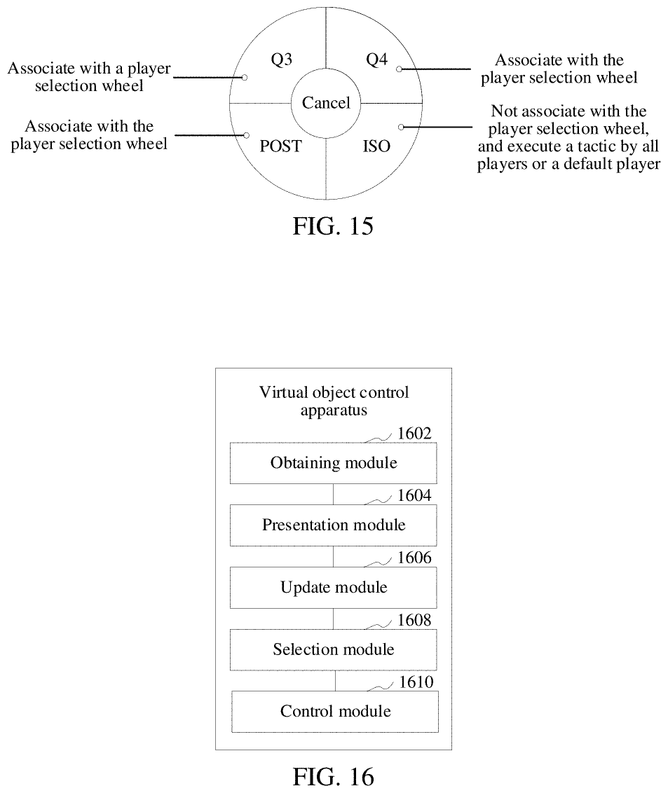

For the tactical buttons on the tactical wheel, some of the tactical buttons may be associated with the player selection wheel, and some of the tactical buttons (that is, directly corresponding tactics, where corresponding tactics that are executed by the default player) are not associated with the player selection wheel, as shown in FIG. 15.

FIG. 12 first presents a tactical wheel, and then presents a player selection wheel (where a button of the player selection wheel may be further associated with another wheel). In addition, according to an actual situation, the player selection wheel may be first presented, and the tactical wheel is then presented (where the button on the tactical wheel may be further associated with another wheel). Examples of corresponding steps of a player selection operation and a tactic selection operation are shown and described with respect to FIG. 12.

Although the steps in the flowcharts of FIG. 2, FIG. 9, and FIG. 12 are sequentially displayed according to indication of arrows, the steps are not necessarily sequentially performed in the sequence indicated by the arrows. Unless clearly specified in this specification, there is no strict sequence limitation on the execution of the steps, and the steps may be performed in another sequence. In addition, at least some of the steps in FIG. 2, FIG. 9, and FIG. 12 may include a plurality of steps or a plurality of stages. The steps or stages are not necessarily performed at the same moment, but may be performed at different moments. The steps or stages are not necessarily executed sequentially, but may be performed in turn or alternately with another step or at least some of steps or stages of the another step.

In an embodiment, as shown in FIG. 16, a virtual object control apparatus is provided. The apparatus may adopt a software module or a hardware module, or a combination thereof to be a part of a computer device. The apparatus includes: an obtaining module 1602, a presentation module 1604, an update module 1606, a selection module 1608, and a control module 1610.

The obtaining module 1602 is configured to obtain a panel presentation instruction generated through triggering on an UI;

the presentation module 1604 is configured to present an interaction control panel on the UI in response to the panel presentation instruction;

the update module 1606 is configured to, when an interaction button on the interaction control panel is triggered, and the interaction button is associated with an object selection panel, replace the interaction control panel with the object selection panel in the UI;

the selection module 1608 is configured to select a to-be-controlled virtual object through the object selection panel; and

the control module 1610 is configured to control the selected virtual object to perform interaction according to an interaction manner corresponding to the interaction button.

In the foregoing embodiment, the obtaining module 1602 is further configured to obtain a panel presentation instruction generated through triggering on a panel presentation button of the UI; and

the presentation module 1604 is further configured to, at a position of the panel presentation button or at a specified position in the UI, present the interaction control panel on the UI in a manner of a pop-up window or a popover.

The term module (and other similar terms such as unit, submodule, etc.) may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module. A module is configured to perform functions and achieve goals such as those described in this disclosure, and may work together with other related modules, programs, and components to achieve those functions and goals.

In the foregoing embodiment, the obtaining module 1602 is further configured to obtain a panel presentation instruction generated through touching on the panel presentation button of the UI; or obtain a panel presentation instruction generated through sliding on the panel presentation button of the UI.

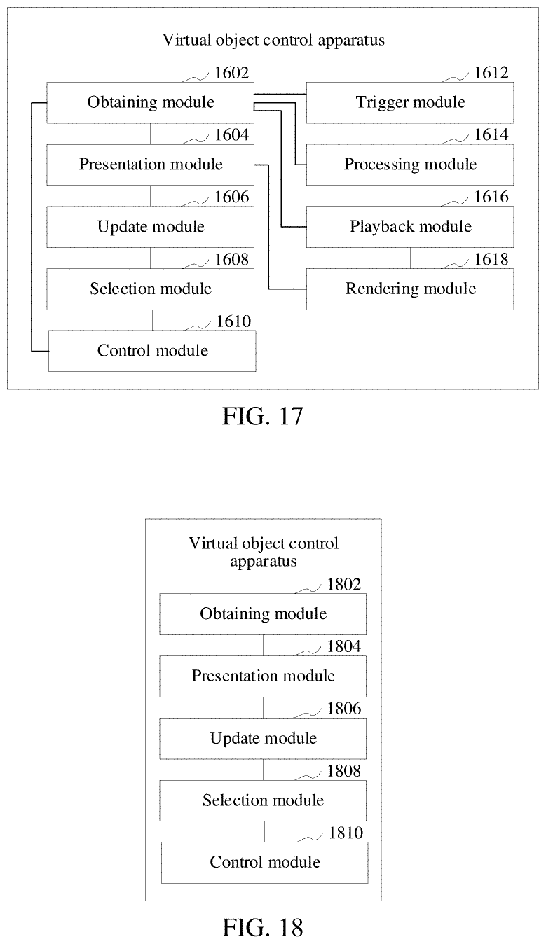

In the foregoing embodiment, as shown in FIG. 17, the apparatus further includes: a trigger module 1612.

The obtaining module 1602 is further configured to, when the panel presentation instruction is an instruction generated through sliding on the panel presentation button, obtain a sliding direction during sliding and/or an end position;

the trigger module 1612 is configured to trigger the interaction button on the interaction control panel according to the sliding direction and/or the end position; and

the obtaining module 1602 is further configured to obtain the interaction manner corresponding to the triggered interaction button.

In an embodiment, as shown in FIG. 17, the apparatus further includes: a processing module 1614.

The processing module 1614 is configured to calculate a touch duration during touching on the panel presentation button; and when the touch duration reaches a preset touch duration, perform the operation of presenting an interaction control panel on the UI;

the obtaining module 1602 is further configured to, when the touch duration does not reach the preset touch duration, obtain an interaction manner used during previous interaction; and

the control module 1610 is further configured to control a currently controlled virtual object to perform interaction according to the obtained interaction manner.

In an embodiment, the presentation module 1604 is further configured to obtain an operation instruction generated by triggering the interaction button in the interaction control panel; determine, when the operation instruction is obtained, whether the interaction button is associated with the object selection panel; determine, when the interaction button is associated with the object selection panel, a first maintaining duration during which the interaction button is triggered; and when the first maintaining duration reaches a first preset duration, replace the interaction control panel with the object selection panel in the UI.

In an embodiment, as shown in FIG. 17, the apparatus further includes: a playback module 1616 and a rendering module 1618.

The playback module 1616 is configured to, when the interaction button is associated with the object selection panel, perform an animation prompt at an edge of the interaction control panel;

the obtaining module 1602 is further configured to obtain object selection panel data;

the rendering module 1618 is configured to render the object selection panel data to obtain the object selection panel; and

the presentation module 1604 is further configured to, when the first maintaining duration reaches a first preset duration, replace the interaction control panel with the object selection panel in the UI.

In an embodiment, the presentation module 1604 is further configured to determine a triggered virtual object selection button in the object selection panel; obtain a virtual object identifier corresponding to the triggered virtual object selection button; and select the to-be-controlled virtual object according to the virtual object identifier from a plurality of virtual objects.

In an embodiment, the processing module 1614 is further configured to, when triggering of the triggered virtual object selection button in the object selection panel ends, calculate a second maintaining duration after the triggering ends; and

the presentation module 1604 is further configured to, when the second maintaining duration reaches a second preset duration, and none of virtual object selection buttons in the object selection panel is triggered, cancel presentation of the presented object selection panel in the UI.

In an embodiment, the obtaining module 1602 is further configured to, when the interaction button on the interaction control panel is triggered, but the interaction button is not associated with the object selection panel, obtain the interaction manner corresponding to the triggered interaction button; and

the control module 1610 is further configured to control a default virtual object to perform interaction according to the obtained interaction manner.

In the foregoing embodiment, by setting the panel presentation button on the UI, when a panel presentation instruction is received, an interaction control panel is presented on the UI, and the user may trigger an interaction button on the interaction control panel to select a corresponding interaction manner. In addition, when the interaction button is triggered and the interaction button is associated with an object selection panel, the object selection panel is displayed, and a to-be-controlled virtual object is selected for interaction through the object selection panel. Consequently, the user does not need to click a to-be-selected virtual object for selection on the UI, thereby effectively avoiding a problem that the to-be-controlled virtual object cannot be selected because the to-be-controlled virtual object is blocked, and improving the interaction effect.

In an embodiment, as shown in FIG. 18, a virtual object control apparatus is provided. The apparatus may adopt a software module or a hardware module, or a combination thereof to be a part of a computer device. The apparatus includes: an obtaining module 1802, a presentation module 1804, an update module 1806, a selection module 1808, and a control module 1810.

The obtaining module 1802 is configured to obtain a panel presentation instruction generated through triggering on an UI;

the presentation module 1804 is configured to present an object selection panel on the UI in response to the panel presentation instruction;

the update module 1806 is configured to, when a virtual object selection button on the object selection panel is triggered, and the virtual object selection button is associated with an interaction control panel, replace the object selection panel with the interaction control panel in the UI;

the selection module 1808 is configured to select a to-be-controlled virtual object corresponding to the virtual object selection button; and

the control module 1810 is configured to control the selected virtual object to perform interaction according to an interaction manner on the interaction control panel.

In the foregoing embodiment, by setting the panel presentation button on the UI, when a panel presentation instruction is received, an object selection panel is presented on the UI, and the user may trigger a virtual object selection button on the object selection panel to select a to-be-controlled virtual object. In addition, when the virtual object selection button is triggered and the virtual object selection button is associated with an interaction control panel, the interaction control panel is displayed, and the virtual object is controlled for interaction by selecting an interaction manner corresponding to the interaction control panel. Consequently, the user does not need to click a to-be-selected virtual object for selection on the UI, thereby effectively avoiding a problem that the to-be-controlled virtual object cannot be selected because the to-be-controlled virtual object is blocked, and improving the interaction effect.

Examples of the virtual object control apparatus are described throughout. All or some of the modules in the virtual object control apparatus may be implemented through software, hardware, or a combination thereof. The foregoing modules may be embedded into or independent of a processor of a computer device in a hardware form, or may be stored in a memory of the computer device in a software form, so that the processor invokes and performs operations corresponding to the modules.

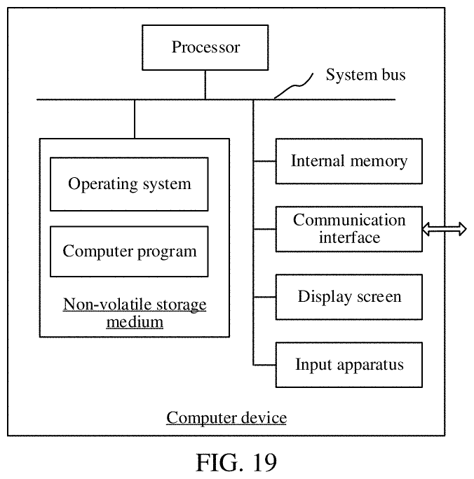

In an embodiment, a computer device is provided. The computer device may be a server, and an internal structure diagram thereof may be shown in FIG. 19. The computer device includes a processor, a memory, and a network interface that are connected through a system bus. The processor of the computer device is configured to provide computing and control capabilities. The memory of the computer device includes a non-volatile storage medium and an internal memory. The non-volatile storage medium stores an operating system, a computer program, and a database. The internal memory provides an environment for running of the operating system and the computer program in the non-volatile storage medium. The database of the computer device is configured to store data related to virtual object control. The network interface of the computer device is configured to communicate with an external terminal through a network connection. The computer program is executed by the processor to implement a virtual object control method.

In an embodiment, a computer device is provided. The computer device may be a terminal, and an internal structure diagram thereof may be shown in FIG. 19. The computer device includes a processor, a memory, a communication interface, a display screen, and an input apparatus that are connected through a system bus. The processor of the computer device is configured to provide computing and control capabilities. The memory of the computer device includes a non-volatile storage medium and an internal memory. The non-volatile storage medium stores an operating system and a computer program. The internal memory provides an environment for running of the operating system and the computer program in the non-volatile storage medium. The communication interface of the computer device is configured to communicate with an external terminal in wired or wireless manner. The wireless manner can be implemented through wireless fidelity (Wi-Fi), an operator network, near field communication (NFC), or other technologies. The computer program is executed by the processor to implement a virtual object control method. The display screen of the computer device may be a liquid crystal display screen or an electronic ink display screen. The input apparatus of the computer device may be a touch layer covering a display screen, or may be a key, a trackball, or a touch panel disposed on a housing of the computer device, or may be an external keyboard, a touch panel, a mouse, or the like.

A person skilled in the art may understand that, the structure shown in FIG. 19 is only a block diagram of a part of a structure related to a solution of this application and does not limit the computer device to which the solution of this application is applied. Specifically, the computer device may include more or fewer members than those in the drawings, or include a combination of some members, or include different member layouts.

In an embodiment, a computer device is further provided, including a memory and a processor, the memory storing a computer program, the processor, when executing the computer program, implementing the operations in the foregoing method embodiments.

In an embodiment, a computer-readable storage medium is provided, storing a computer program, the computer program, when executed by a processor, implementing the operations in the foregoing method embodiments.

In an embodiment, a computer program product or a computer program is provided, the computer program product or the computer program including computer instructions, the computer instructions being stored in a computer-readable storage medium. A processor of a computer device reads the computer instructions from the computer-readable storage medium and executes the computer instructions, causing the computer device to perform the operations in the foregoing method embodiments.

A person of ordinary skill in the art may understand that some or all procedures in the foregoing method embodiments may be implemented by a computer program instructing related hardware. The computer program may be stored in a non-volatile computer-readable storage medium, and when the computer program is executed, the procedures of the foregoing method embodiments may be performed. Any reference to a memory, a storage, a database, or another medium used in the embodiments provided in this application may include at least one of a non-volatile memory and a volatile memory. The non-volatile memory may include a read-only memory (ROM), a magnetic tape, a floppy disk, a flash memory, an optical memory, and the like. The volatile memory may include a random access memory (RAM) or an external cache. For the purpose of description instead of limitation, the RAM is available in a plurality of forms, such as a static RAM (SRAM) or a dynamic RAM (DRAM).

The technical features in the foregoing embodiments may be combined in different embodiments. For concise description, not all possible combinations of the technical features in the embodiments are described. However, provided that combinations of the technical features do not conflict with each other, the combinations of the technical features are considered as falling within the scope described in this specification.

The foregoing embodiments only describe several implementations of this application, which are described specifically and in detail, but cannot be construed as a limitation to the patent scope of the present invention. For a person of ordinary skill in the art, several transformations and improvements can be made without departing from the idea of this application. These transformations and improvements belong to the protection scope of this application. Therefore, the protection scope of the patent of this application is subject to the appended claims.

1. A virtual object control method comprising:
obtaining a panel presentation instruction generated through a triggering from a user interface;
presenting a first panel on the user interface in response to the panel presentation instruction;
initiating, while a first movement on the first panel is triggered and when the first movement is associated with a second panel, an interaction manner corresponding to the triggered first movement; and
replacing, while the first movement on the first panel is triggered and when the first movement is associated with the second panel, the first panel with the second panel in the user interface, wherein the second panel comprises several movements.

2. The method according to claim 1, wherein the obtaining the panel presentation instruction further comprises:
obtaining a panel presentation instruction generated through triggering on a panel presentation movement of the user interface; and
wherein the presenting the first panel on the user interface further comprises:
presenting, at a position of the panel presentation movement or at a specified position in the user interface, the first panel on the user interface in a manner of a pop-up window or a popover.

3. The method according to claim 2, wherein the obtaining the panel presentation instruction further comprises:
obtaining the panel presentation instruction generated through touching on the panel presentation movement of the user interface; or
obtaining the panel presentation instruction generated through sliding on the panel presentation movement of the user interface.

4. The method according to claim 3, further comprising:
obtaining, when the panel presentation instruction is an instruction generated through sliding on the panel presentation movement, a sliding direction during sliding or an end position;
triggering the interaction movement on the first panel according to the sliding direction or the end position; and
initiating the interaction manner corresponding to the triggered interaction movement.

5. The method according to claim 3, further comprising:
calculating a touch duration during the touching on the panel presentation movement;
performing, when the touch duration reaches a preset touch duration, the operation of presenting the first panel on the user interface; and
obtaining, when the touch duration does not reach the preset touch duration, an interaction manner used during previous interaction is initiated;
controlling, when the touch duration does not reach the preset touch duration, a currently controlled virtual object to perform interaction according to the interaction manner.

6. The method according to claim 1, wherein the interaction manner further comprises:
obtaining an operation instruction generated by triggering the interaction movement in the first panel;
determining, when the operation instruction is obtained, whether the interaction movement is associated with the second panel;
determining, when the interaction movement is associated with the second panel, a first maintaining duration during which the interaction movement is triggered; and
replacing, when the first maintaining duration reaches a first preset duration, the first panel with the second panel in the user interface.

7. The method according to claim 6, further comprising:
performing, when the interaction movement is associated with the second panel, an animation prompt at an edge of the first panel;
obtaining second panel data;
rendering the second panel data to obtain the second panel; and
performing, when the first maintaining duration reaches the first preset duration, the operation of replacing the first panel with the second panel in the user interface.

8. The method according to claim 1, wherein the selecting the to-be-controlled virtual object further comprises:
determining a triggered virtual object selection movement in the second panel;
obtaining a virtual object identifier corresponding to the triggered virtual object selection movement; and
selecting the to-be-controlled virtual object according to the virtual object identifier from a plurality of virtual objects.

9. The method according to claim 8, further comprising:
calculating, when triggering of the triggered virtual object selection movement in the second panel ends, a second maintaining duration after the triggering ends; and
canceling, when the second maintaining duration reaches a second preset duration and none of virtual object selection movements in the second panel are triggered, presentation of the presented second panel in the user interface.

10. The method according to claim 1, further comprising:
obtaining, when the interaction movement on the first panel is triggered, but the interaction movement is not associated with the second panel, the interaction manner corresponding to the triggered interaction movement is initiated; and
controlling a default virtual object to perform interaction according to the interaction manner.

11. The method according to claim 1, wherein the first panel or the second panel is displayed outside of a center area of the user interface to avoid interference of the center area.

12. A virtual object control method comprising:
obtaining a panel presentation instruction generated through triggering on a user interface;
presenting a second panel on the user interface in response to the panel presentation instruction;
replacing, while a virtual object selection movement on the second panel is triggered and the virtual object selection movement is associated with first panel, the second panel with the first panel in the user interface;
selecting a to-be-controlled virtual object corresponding to the virtual object selection movement while the virtual object selection movement on the second panel is triggered; and
controlling the selected virtual object to perform interaction according to an interaction manner on the first panel.

13. The method according to claim 12, wherein the obtaining the panel presentation instruction generated through triggering on the user interface further comprises:
obtaining a panel presentation instruction generated through triggering on a panel presentation movement of the user interface; and
wherein the presenting the second panel on the user interface further comprises:
presenting, at a position of the panel presentation movement or at a specified position in the user interface, the second panel on the user interface in a manner of a pop-up window or a popover.

14. The method according to claim 13, wherein the obtaining the panel presentation instruction generated through triggering on a panel presentation movement of the user interface comprises:
obtaining the panel presentation instruction generated through touching on the panel presentation movement of the user interface; or
obtaining the panel presentation instruction generated through sliding on the panel presentation movement of the user interface.

15. The method according to claim 14, further comprising:
obtaining, when the panel presentation instruction is an instruction generated through sliding on the panel presentation movement, a sliding direction during sliding or an end position;
triggering the virtual object selection movement on the second panel according to the sliding direction or the end position; and
initiating an interaction manner corresponding to the triggered virtual object selection movement.

16. The method according to claim 12, wherein after the selecting the to-be-controlled virtual object, the method further comprises:
calculating, when triggering of an interaction control movement in the first panel ends, a second maintaining duration after the triggering ends; and
canceling, when the second maintaining duration reaches a second preset duration and none of virtual object selection movements in the second panel are triggered, presentation of the presented first panel in the user interface.

17. The method according to claim 16, further comprising:
determining a presentation position before the canceling of the presentation of the first panel; and
presenting, when the presentation of the first panel is canceled, the first panel at the presentation position.

18. The method according to claim 12, wherein the first panel or the second panel is displayed outside of a main focus of the user interface to avoid interference with the main focus.

19. The method according to claim 1, further comprising:
collapse the first panel and the second panel upon completion of the triggering.

20. A virtual object control apparatus, comprising:
an obtaining module, configured to obtain a panel presentation instruction generated through triggering on a user interface;
a presentation module, configured to present an first panel on the user interface in response to the panel presentation instruction;
an update module, configured to, while an interaction movement on the first panel is triggered and the interaction movement is associated with an second panel, replace the first panel with the second panel in the user interface;
a selection module, configured to select a to-be-controlled virtual object through the second panel while the interaction movement on the first panel is triggered; and
a control module, configured to control the selected virtual object to perform interaction according to an interaction manner corresponding to the interaction movement.

21. The virtual object control apparatus according to claim 19, wherein the presentation module is further configured to present the second panel on the user interface in response to the panel presentation instruction, further wherein the update module is further configured to replace the second panel with the first panel in the user interface, further wherein the selection module is further configured to select the to-be-controlled virtual object corresponding to the virtual object selection movement, further wherein the control module is further configured to control the selected virtual object to perform the interaction according to an interaction manner on the first panel.
